(19) United States
(12) Patent Application Publication
(10) Pub. No.: US 2003/0196465 A1
(43) Pub. Date: Oct. 23, 2003

(54) Closing device for a vehicle

(76) Inventors: Rolf Buecker, Coburg (DE); Joerg Uebelein, Grub am Forst (DE); Uwe Sommer, Effelder (DE); Andre Goertz, Dresden (DE)

Correspondence Address: CHRISTIE, PARKER & HALE, LLP, 350 WEST COLORADO BOULEVARD, SUITE 500, PASADENA, CA, 91105, US

(21) Appl. No.: 10/380,391

(22) PCT Filed: Sep. 4, 2001
(86) PCT No.: PCT/DE01/03436

(30) Foreign Application Priority Data
Sep. 12, 2000 (DE) 10046188.3

(51) Int. Cl. E05B 47/00

(52) U.S. Cl. 70/277

(57) ABSTRACT

The invention relates to a closing device for a vehicle comprising a lock, a drive for determining the locking state of the locking device, by means of which the locking device may he placed in at least four different locking states and a rotating shaped disc on the drive, which may he rotated by the drive to determine the individual locking states, whereby the individual locking states are each assigned a particular angular position for the shaped disc. According to the invention, the shaped disc (1) is of such a form that said disc may be taken from each angular position, corresponding to one of the various states (V, K, S) and different to the unlocked state (E), without a third locking state occurring on performing the above.

The invention relates to a closing device for a vehicle according to the preamble of claim 1 or claim 2.

A closing device of this kind comprises at least one lock; a drive for determining the locking states of the closing device (i.e. the locking states of the lock or locks), through which the closing device can be brought into at least three or four different locking states which correspond for example to the unlocked, locked, dead-lock and child-lock state; as well as a rotary mounted shaped disc on the drive which can be rotated by the drive to determine the individual locking states, whereby the different locking states are each assigned specific angular positions of the shaped disc.

With a closing device of this kind which is known from DE 199 17 789 A1 the shaped disc is formed by a drive disc which is provided with internal and external protrusions and is scanned by one end of a lever. The other end of the lever is assigned to the lock (that is the locking parts of the closing device such as e.g. the rotary latch and locking pawl) and influences the interaction of an operating device such as e.g. an inside door handle or outside door handle, with the lock. Thus for example in the dead-lock state of the closing device the lock cannot be actuated by either the inside handle or by means of the outside handle. This means that any actuation of the inside door handle or outside door handle is not transferred to the corresponding lock elements (e.g. locking pawl and rotary catch). Conversely in the unlocked state of the closing device the door can be opened both by means of the inside handle and by means of the outside handle. In a corresponding way further locking states, such as e.g. the locked or child-lock state can be similarly defined.

The object of the invention is to improve a closing device of the type mentioned at the beginning, more particularly with regard to its ease of operation.

This is achieved according to the invention by providing a closing device which has the features of the patent claim 1 and patent claim 2.

According to this with a shaped disc through which the closing device can be brought into at least four different locking states the shaped disc is designed so that it can be brought from any angular position which corresponds to a state different from the unlocked state (e.g. locked state, dead-lock or child-lock state) directly into an angular position which corresponds to the unlocked state without hereby passing through a third locking state.

The solution according to the invention can be provided in a concrete form e.g. in that the individual closing states are each assigned to specific angular regions on the shaped disc whereby the angular regions are arranged in succession around the circumference of the shaped disc and each angular region of the shaped disc which is assigned to a state which is different from the unlocked state is adjoined directly by an angular region which is assigned to the unlocked state.

With the solution according to the invention therefore the individual locking states are not simply arranged one behind the other on the shaped disc but at each angular region which corresponds to a state different from the unlocked state there is at least one defined angular region which corresponds to the unlocked state. For this purpose several angular regions have to be provided on the shaped disc which each correspond to the unlocked state.

The solution according to the invention has the advantage that a very rapid change-over is possible from each locking state which is different from the unlocked state, into the unlocked state. The solution according to the invention can be used with particular advantage in the case of so-called keyless-entry or passive-entry systems where the closing device is changed automatically into the unlocked state when a person who has been identified by the system as an authorised driver of the vehicle approaches the vehicle and actuates the outside door handle thereof. The authorised user can be identified for example by a signal transmitter which he carries around.

With a closing system of this kind it is necessary that after the authorised user has been identified and as he actuates the outside door handle the closing device is brought very rapidly into the unlocked state. Otherwise the door would not open immediately as the outside door handle is actuated which would be seen by the user as a defect or at least as a nuisance. Problems of this kind can arise particularly when the closing device is located in a locking state which is still separated from the unlocked state by further locking states. The rapid change into the unlocked state which is desirable to overcome these problems is guaranteed by the solution according to the invention.

The closing device which is configured according to the invention can be used both in closing systems which have only one lock (e.g. closing device for a single vehicle door) and also in closing systems which are used for actuating several locks (central locking in motor vehicles).

According to claim 2 with a closing device having a drive with which the closing device can be brought into at least three different locking states the shaped disc is designed so that as the disc is rotated along a predeterminable rotary direction the unlocked state always follows a state which is different from the unlocked state. In other words there is at least one rotary direction having the property where as the shaped disc rotates along this rotary direction a region corresponding to the unlocked state always follows each region of the shaped disc which has a state different from the unlocked state.

In this case it is thus not only ensured that each state which is different from the unlocked state on the shaped disc is adjoined by a region which corresponds to the unlocked state, but it is also guaranteed that as the shaped disc rotates along a certain rotary direction a direct change into the unlocked state is possible each time.

The shaped disc according to the invention can be simply formed by a disc-like body which extends in one plane and which can be formed in particular in one piece. Thus the shaped disc can be formed by a cam disc where the outer and/or inner contour represent the different locking states.

The unlocked state of the closing device preferably corresponds to a locking state in which each lock is unlocked. There is then only one single clearly defined unlocked locking state, namely the state of the closing device in which all locks are unlocked so that the corresponding flaps of the vehicle (e.g. vehicle doors in the case of door locks) can be opened without child locks or anti-theft locks.

The shaped disc interacts with a coupling element which scans the shaped disc and couples an actuating device (e.g. outside handle or inside handle) to the lock or uncouples it from the lock, depending on the angular position of the shaped disc. Only when the relevant actuating device is coupled to the lock can this be actuated in order to open the door.

By using two coupling elements which scan the shaped disc and couple or uncouple the actuating device with or from the lock depending on the angular position of the shaped disc the locking states which are defined by the shaped disc can be transferred to two different actuating devices (more particularly to an outside door opener and inside door opener).

To this end on the one hand two contours can be provided radially spaced from each other on the shaped disc, each interacting with one of the two coupling elements. On the other hand the two coupling elements can scan the same contour on the shaped disc whereby in this case the two coupling elements are disposed spaced from each other along the circumferential direction of the shaped disc.

The shaped disc itself can be rotated by means of a drive which can be set in motion by actuating a closing cylinder of the lock, remote control (e.g. through a passive-entry system) or by some other closing element.

Further features and advantages of the invention will now be explained with reference to the following description of the embodiment shown in the drawings in which:

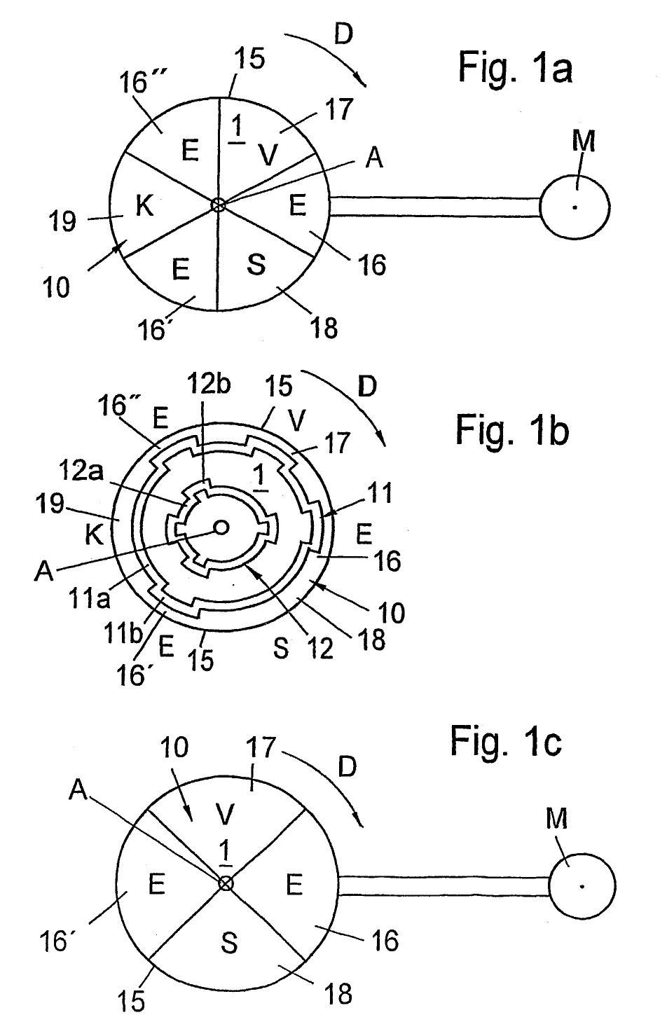

FIG. 1a shows diagrammatically a shaped disc which can be driven by means of a motor and through which four different locking states of one closing device can be defined;

FIG. 1b shows a concrete embodiment of the shaped disc of FIG. 1a;

FIG. 1c shows a diagrammatic view of a shaped disc which can be rotated by means of a drive and through which three different locking states of a closing device can be defined;

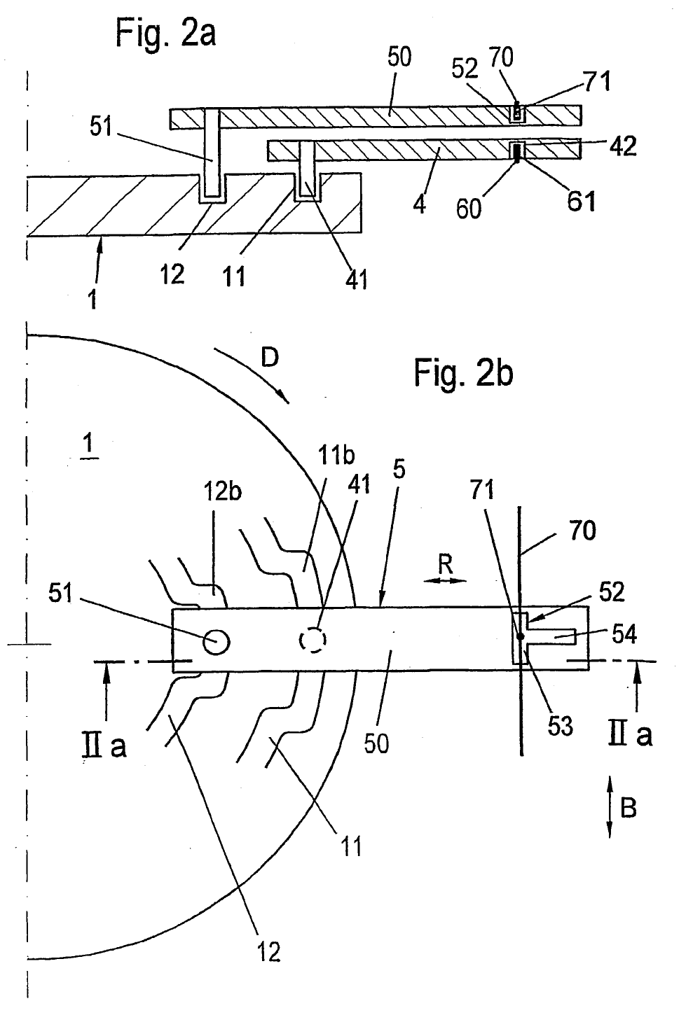

FIG. 2a shows a cross-section through a part of the shaped disc of FIG. 1b having two coupling elements which scan the shaped disc;

FIG. 2b shows a plan view of FIG. 2a;

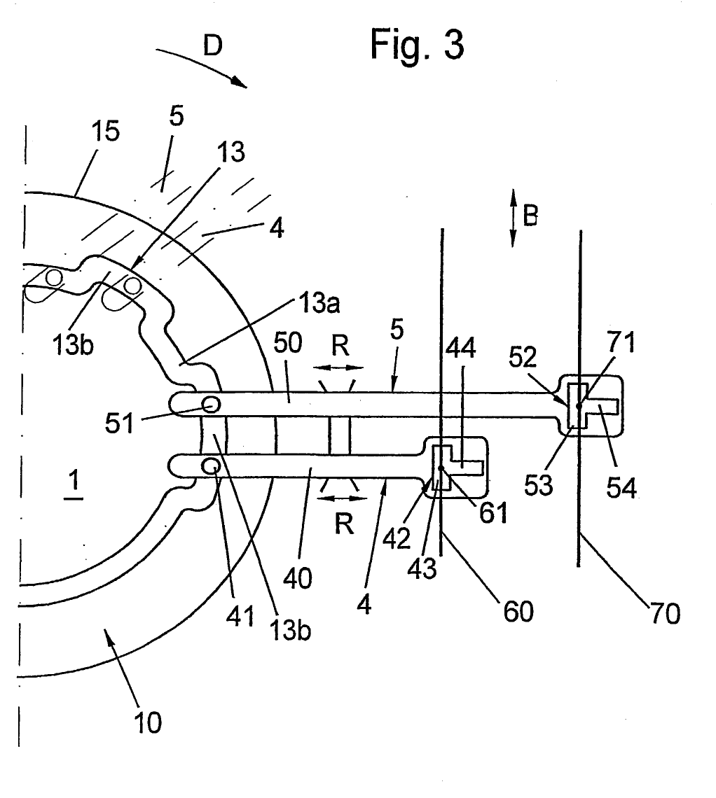

FIG. 3 shows a plan view of a modification of the embodiment of FIG. 2b;

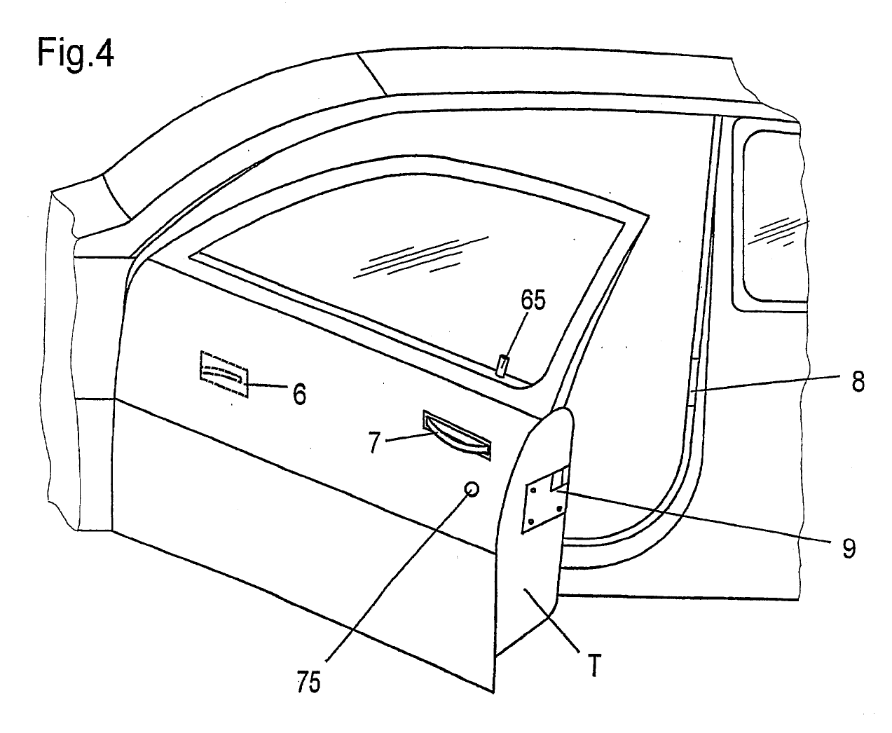

FIG. 4 shows a diagrammatic view of a motor vehicle door;

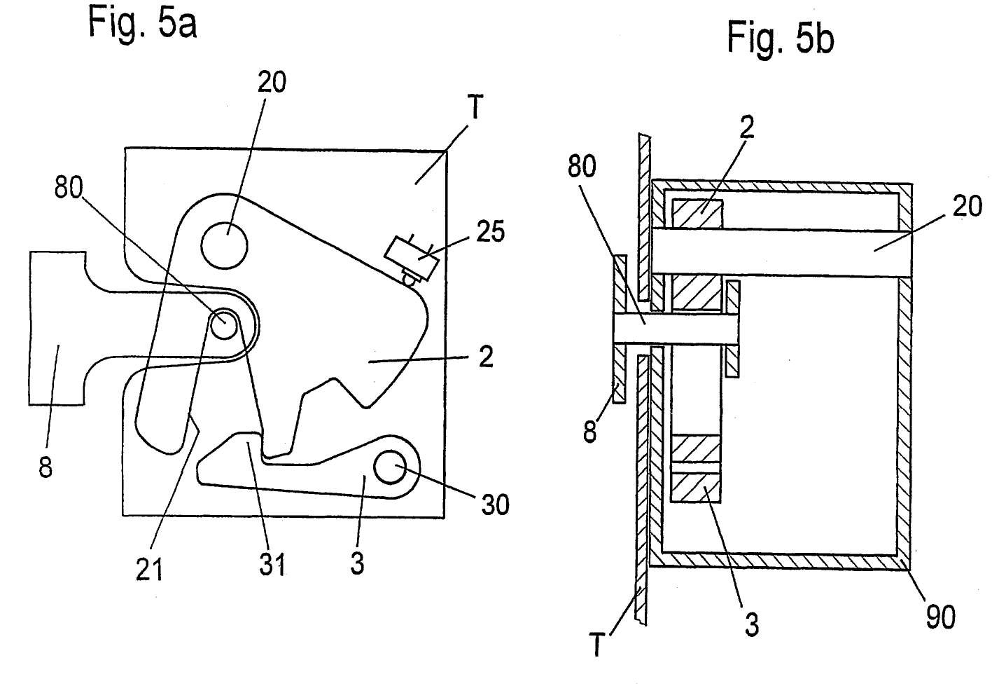

FIGS. 5a and 5b each show a diagrammatic view of the structure of a door lock.

FIG. 4 shows part of the side of a vehicle body with a door T whose closing device has in known way an inside door opener in the form of an inside door handle 6, an internal locking button 65, an outside door opener in the form of an outside door handle 7 as well as a closing cylinder 75 and a door lock 9. The door lock 9 is assigned a holder 8 which is mounted on the side of the body and with which the lock parts of the door lock can be brought into engagement in order to lock the door.

A diagrammatic illustration of a door lock and the associated holder in FIGS. 5a and 5b shows the lock parts of the door lock, namely a locking pawl 3 with hook 31 capable of swivelling about an axis 30, and a rotary catch 22 with recess 21 which is capable of swivelling about an axis 20 and interacts with the locking pawl 3, with the recess 21 associated with a locking pin 80 of the holder 8. Furthermore a measuring scanner 25 is provided with which the external contour of the rotary catch 2 can be scanned in order to determine the rotary angle thereof. The lock parts 2, 3 (rotary catch and locking pawl) which make up the lock are mounted in a lock housing 90 which is fixed on the door panel.

A closing device of the kind described above is generally known and therefore needs no further explanation.

Of importance to the present invention is the configuration of a shaped disc by means of which the different locking states of the closing device can be established. The essential locking states are thereby the unlocked state, the locked state, the “child-lock” locking state as well as the “dead-lock” locking state. By unlocked state is thereby meant that locking state in which the lock can be actuated to open the door both by means of the inside door handle and the outside door handle. In the locked state however the outside door handle is uncoupled from the lock so that the door cannot be opened by actuating the outside door handle. Conversely in the “child-lock” locking state the inside door handle is uncoupled from the lock so that the door cannot be opened by actuating the inside door handle. In the “dead-lock” locking state both the inside door handle and the outside door handle are uncoupled from the door lock so that it cannot be actuated by either the inside door handle nor by means of the outside door handle for opening the door.

With a closing device for controlling several locks in the “child-lock” locking state often only the rear doors of a vehicle are correspondingly secured whilst the front doors are located in the unlocked state. Nevertheless the child-lock state of the closing device clearly differs from the unlocked state, namely with regard to the state of the locks of the rear doors.

FIG. 1a shows diagrammatically a shaped disc 1 with which the locking states listed above can be established. The shaped disc 1 consists of a disc-shaped base body 10 mounted rotatable about an axis A and capable of being rotated by means of a drive M. The drive M can be triggered for example by operating the closing cylinder or by means of remote control in order to change the actual locking state through rotation of the shaped disc 1.

The shaped disc 1 is divided along its circumference into 6 identical sections or angular regions 16, 16′, 16″, 17, 18 and 19 which are arranged one behind the other around the circumference 15 of the disc-shaped base body 10 and which each cover an angular range of 60°.

Of the said sections, three sections 16, 16′, 16″ are assigned the unlocking state E, one section 17 is assigned the locking state V, one section 18 is assigned the “dead-lock” locking state S and a further section 19 is assigned the “child-lock” locking state K. The sections or angular regions 16 to 19 of the shaped disc 1 assigned to the individual locking states E, V, S, K are thereby arranged in succession so that as the shaped disc 1 is rotated about its axis A along a direction D (clockwise) the unlocked state E each time directly follows a locking state K, S, V which is different from the unlocked state E. This also applies when the shaped disc 1 is rotated in the opposite direction, thus anti-clockwise.

From FIG. 1a it is clear that one section or angular region (16″) corresponding to the unlocked state E could be omitted and that nevertheless for each of the sections or angular regions 17 to 19 which represent a locking state V, S or K which is different from the unlocked state E, a section or angular region 16, 16′ would be adjacent which corresponds to the unlocked state E. In this case however the direct change from the locking state V (locked) or from the locking state K (child-lock) into the locking state E (unlocked) would no longer be possible in each rotary direction of the shaped disc 1. The direct change from the locking state K (child-lock) into the locking state E (unlocked) would rather be possible only when the shaped disc 1 is rotated clockwise and the direct change from the locking state V (locked) into the locking state E (unlocked) would only be possible when the shaped disc is rotated anti-clockwise.

Only if overall three sections or angular regions 16, 16′, 16″ of the shaped disc represent the unlocked state E is it ensured that with a rotary movement along just one rotary direction D the unlocked state E each time directly follows each locking state V, S, K which is different from the unlocked state E.

FIG. 1b shows an embodiment of a concrete design of the shaped disc 1 shown diagrammatically in FIG. 1a. The shaped disc 1 illustrated in FIG. 1b has in its disc-shaped base body 10 two radially spaced contours 11, 12 running in the circumferential direction 15 of the shaped disc 1. The contours 11, 12 are each formed by a circumferential guideway 11a and 12a respectively which are provided with radially projecting protrusions 11b, 12b. The protrusions 11b, 12b are each arranged spaced from each other in the circumferential direction of the corresponding contour 11, 12 and form a constituent part of the corresponding contour 11 and 12.

The two contours 11, 12 of the shaped disc 1 are each scanned by a coupling element as explained further below with reference to FIGS. 2a and 2b.

A coupling element which is guided in one of the contours 11, 12 is each time then moved outwards in a radial direction when as the shaped disc 1 rotates about its axis A one of the protrusions 11b, 12b is sensed by the corresponding coupling element. In the present case it may be assumed that by scanning the outer contour 11 by means of a coupling element the inside door handle of the closing device is coupled with the lock or uncoupled from same whilst by scanning the inner contour 12 by means of a further coupling element the outside door handle is uncoupled from the door lock or coupled with same. A coupling between the corresponding actuating device (outside door handle or inside door handle) and the door lock should then exist whenever the associated coupling element detects a protrusion 11b, 12b.

In this case the unlocked state E is characterised each time by such an angular range 16, 16′, 16″ of the shaped disc 1 in which both contours 11, 12 have a protrusion 11b, 12b respectively. For in this case both the outside door handle and the inside door handle are coupled to the lock so that the door can be opened both by actuating the outside door handle and by actuating the inside door handle.

In the angular region 17 of the shaped disc 1 which represents the locked state V only the outer contour 11 has a protrusion 11b. Correspondingly the door can only be opened by actuating the inside door handle whilst opening the door by actuating the outside door handle is not possible.

Conversely in the “child-lock” locking state which is represented by the angular region 19 of the shaped disc 1 only the inner contour 12 has a protrusion 12b so that the door can only be opened by actuating the outside door handle and not however by actuating the inside door handle.

In the section or angular region 18 of the shaped disc 1 which corresponds to the “dead-lock” state, finally neither of the two contours 11, 12 has a protrusion. Therefore in this state the door lock cannot be actuated to open the door by either the outside door handle or inside door handle.

In FIGS. 2a and 2b it shows however that the shaped disc 1 illustrated in FIG. 1 is scanned by means of two coupling elements 4, 5 whereby the one coupling element 4 scans the outer contour 11 and the other element 5 scans the inner contour 12.

Each of the two coupling elements 4, 5 consists of a coupling rod 40, 50 which is mounted radially relative to the shaped disc 1 and which is provided at its end facing the shaped disc 1 with a pin 41, 51 respectively engaging in the corresponding contour 11 and 12. At their ends remote from the shaped disc 1 the coupling rods 40, 50 are provided on the other hand with a T-shaped recess 42, 52. A connecting member 60, 70 runs through these recesses 42, 52 across the extension direction of the coupling rods 40, 50 to engage by a pin 61, 71 in the associated recess 42, 52. Through the one connecting member 60 the door inside handle is coupled to the door lock and through the other connecting member 70 the outside door handle is coupled to the door lock. When the inside door handle or outside door handle is actuated for the purpose of opening the door the control movement is transferred through the corresponding connecting member 60, 70 to the door lock in order to enable the door to be opened through action on the door lock. The corresponding connecting member 60, 70 is hereby moved in an actuating direction B across the extension direction of the coupling rods 40, 50.

This movement is in any case only possible when the pin 61, 71 of the relevant connecting member 60, 70 projects in a section 43, 53 of the recess 42, 52 (see also FIG. 3) which permits movement of the connecting member 60, 70 in the actuating direction B across the extension direction of the coupling rods 40, 50.

In the plan view of FIG. 2b it is clear from the coupling rod 50 assigned to the outside door handle that the T-shaped recess 52 forms a first section 53 which permits a movement of the connecting member 70 in the actuating direction B across the extension direction of the coupling rod 50, as well as a second section 54, which does not permit a movement of the connecting member 70 in the actuating direction B; for the pin 71 which protrudes from the connecting member 70 down into the recess 52 is blocked as far as movement in the actuating direction B is concerned when it is located in the last-mentioned section 54 of the recess 52.

Furthermore it is clear from FIGS. 2a and 2b that the coupling rods 40, 50 are guided outwards in a radial direction when their pins 41, 51 are located in a protrusion 11b, 12b of the relevant contour 11, 12. In this state which is shown in FIG. 2b by way of example from the coupling rod 50 associated with the outside door handle, the associated connecting member 70 engages with its pin 71 in that section 53 of the recess 52 which enables the connecting member to move into the actuating direction B. Then the outside door handle is coupled through the connecting member 70 to the lock so that the door can be opened by actuating the outside door handle.

The same applies in the state according to FIG. 2a and 2b for the inside door handle since the coupling rod 40 associated with the inside door handle also engages by its pin 41 in a protrusion 11b of the associated contour 11 on the shaped disc 1.

If now by rotating the shaped disc 1 along the rotary direction D the pin 41, 51 of one of the coupling elements 4, 5 is guided into a section of the associated contour 11, 12 which forms no protrusion then the corresponding pin 61, 71 of the associated connecting member 60, 70 engages in a section 44, 54 of the relevant recess 42, 52 which blocks movement of the connecting member in the actuating direction B. The corresponding actuating device (inside door handle or outside door handle ) is then uncoupled from the door lock so that the door cannot be opened by actuating the said actuating device.

FIG. 3 shows a further concrete embodiment of the shaped disc 1 shown diagrammatically in FIG. 1a. This is a modification of the embodiment illustrated in FIGS. 1b, 2a and 2b. Therefore only the differences from this embodiment will be explained below. Parts which coincide are therefore provided with the same reference numerals.

With the embodiment of a shaped disc 1 illustrated in FIG. 3 only one contour 13 is provided in its disc-shaped base body 10 which consists of a circumferential guideway 13a which has a number of circumferentially spaced out radially outwardly projecting protrusions 13b.

Two coupling elements 4, 5 set spaced out along the circumference 15 of the shaped disc 1 each engage by a pin 41 and 51 respectively in this contour 13. The two coupling elements 4, 5 hereby scan different regions of the contour 13.

In the state shown in FIG. 3 the two coupling elements 4, 5 engage by their pins 41, 51 in a protrusion 13b of the contour 13. The closing device is therefore located in the unlocked state in which the lock can be actuated both by means of the inside door opener and outside door opener for the purpose of opening the door. This can be seen in FIG. 3 whereby both connecting members 60, 70 each engage by their pins 61, 71 in such a section 43, 53 of the associated recesses 42, 52 of a coupling rod 40, 50 that movement of the relevant connecting member 60, 70 in the actuating direction B is possible.

If the shaped disc 1 is rotated clockwise out from this position in the rotary direction D so far that the two coupling elements 4, 5 engage in the contour 13 of the shaped disc 1 in the manner shown by dotted lines in FIG. 3, then another situation arises regarding the coupling of the actuating devices of the closing device with the door lock. (In FIG. 3 for reasons of clarity an illustration is selected in which the position of the two coupling elements 4, 5 was rotated anti-clockwise relative to the shaped disc 1. In actual fact obviously the shaped disc 1 is rotated clockwise and the two coupling elements 4, 5 remain spatially unchanged. Since however for fixing the locking states it is only a matter of the position of the shaped disc 1 relative to the coupling elements 4, 5 the simplified illustration selected in FIG. 3 is permissible).

In the state illustrated by dotted lines in FIG. 3 a coupling element 4 engages in a section 13a of the contour 13 which forms no protrusion whilst the other coupling element 5 engages in a section 13b of the contour 13 which forms a radial protrusion. One of the actuating devices is hereby uncoupled from the door lock whilst the door lock can be actuated with the other actuating device for the purpose of opening the door.

Since in the state indicated by dotted lines in FIG. 3 only the coupling element 5 assigned to the outside door opener engages in a protrusion 13b of the contour 13, in this state the door can only be opened by actuating the outside door handle. This then represents the “child-lock” locking state.

FIG. 1c shows diagrammatically only one embodiment of a shaped disc 1 with which only three different locking states, namely for example the unlocked state E, the locked state V and the “dead-lock” locking state S can be fixed. Each of these states E, V, S is assigned to a section or angular region 16, 16′, 17, 18 of the shaped disc 1. Thus for the unlocked state E two sections or angular regions 16, 16′ are provided so that in one rotary direction D of the shaped disc 1 each second section or angular region is assigned to the unlocked state E. It is hereby ensured that as the shaped disc 1 is rotated in the rotary direction D the unlocked state E always directly follows each locking state V, S which is different from the unlocked state E.

Also in this figure the drive M which is coupled to the shaped disc 1 and is provided for rotating the shaped disc 1 is shown diagrammatically.

1. Closing device for a vehicle with
at least one lock
a drive fixing the locking states of the closing device and with which the closing device can be brought into at least four different locking states; and
a rotatably mounted shaped disc of the drive which can be rotated by a drive for determining the individual locking states whereby the individual locking states are each assigned to specific angular positions of the shaped disc
characterised in that
the shaped disc (1) is designed so that it can be brought from each angular position which corresponds to a state (V, K, S) which is different form the unlocked state directly into an angular position corresponding to the unlocked state (E) of the closing device without any third locking state occurring.

2. Closing device for a vehicle with
at least one lock
a drive fixing the locking states of the closing device and with which the closing device can be brought into at least three different locking states; and
a rotatably mounted shaped disc of the drive which can be rotated by a drive for determining the individual locking states whereby the individual locking states are each assigned to specific angular positions of the shaped disc
characterised in that
the shaped disc (1) is formed so that when the shaped disc (1) is rotated along a predeterminable rotary direction (D) the unlocked state (E) always follows a state (V, K, S) of the closing device which is different form the unlocked state.

3. Closing device according to claim 1 or 2, characterised in that the individual locking states (E, V, K, S) of the closing device are each assigned to specific angular regions (16, 16′, 16″, 17, 18, 19) on the shaped disc (1) and that the angular regions (16, 16′, 16″, 17, 18, 19) are arranged in succession in the circumferential direction of the shaped disc (1).

4. Closing device according to claim 3, characterised in that each angular region (17, 18, 19) of the shaped disc (1) which is assigned to a state (V, K, S) which is different from the unlocked state is directly adjoined by an angular region (16, 16′, 16″) which is assigned to the unlocked state (E).

5. Closing device according to claim 4, characterised in that along a predeterminable direction (D) along the circumference (15) of the shaped disc (1) each angular region (17, 18, 19) which is assigned to a state (V, K, S) which is different from the unlocked state is adjoined directly by an angular region (16, 16′, 16″) which is assigned to the unlocked state (E).

6. Closing device according to claim 5, characterised in that each angular region (17, 18, 19) of the shaped disc (1) which is assigned to a state (V, K, S) which is different from the unlocked state is defined directly by two angular regions (16, 16′, 16″) which are assigned to the unlocked state (E).

7. Closing device according to one of the preceding claims characterised in that the shaped disc (1) is formed by a disc-like body extended in one plane.

8. Closing device according to one of the preceding claims characterised in that the shaped disc (1) is formed by a cam disc.

9. Closing device according to one of the preceding claims characterised in that in the unlocked state of the closing device each lock of the closing device is unlocked.

10. Closing device according to one of the preceding claims characterised in that the shaped disc (1) interacts with a coupling element (4, 5) which scans the shaped disc (1) and which couples an actuating device (6, 7) to the lock (9) or uncouples it from the lock (9) depending on the angular position of the shaped disc (1).

11. Closing device according to one of the preceding claims characterised in that the closing device is assigned two different actuating devices (6, 7), more particularly an outside door opener and an inside door opener which are in active connection with the lock (9) through the drive.

12. Closing device according to claim 11 characterised in that the shaped disc (1) interacts with two coupling elements (4, 5) which scan the shaped disc (1) and which each couple one of the actuating devices (6, 7) to the lock (9) or uncouple it from the lock (9) depending on the angular position of the shaped disc (1).

13. Closing device according to claim 12 characterised in that two radially spaced contours (11, 12) are provided on the shaped disc (1) and each interact with one of the coupling elements (4, 5).

14. Closing device according to claim 13 characterised in that the two coupling elements (4, 5) scan the same contour (13) and are spaced from each other along the circumference (15) of the shaped disc (1).

15. Closing device according to one of the preceding claims characterised in that the closing device has the “locked” locking state and/or the “child lock” locking state and/or the “dead-lock” locking state.

16. Closing device according to one of the preceding claims characterised in that the shaped disc (1) is rotatable by means of a drive (M) which can be set in operation by actuating a closing cylinder or a remote control of the closing device.

17. Closing device according to claim 16 characterised in that the drive (M) can be set in operation by a passive-entry mechanism.

18. Closing device according to one of the preceding claims characterised in that the closing device comprises at least two locks and that in the unlocked state of the closing device each of the locks is unlocked.

19. Closing device according to claim 18 characterised in that several locks are assigned just one shaped disc (1) for establishing the relevant locking state of the closing device.

20. Vehicle door with a closing device according to one of the previous claims.
